(19) United States
(12) Patent Application Publication
(10) Pub. No.: US 2016/0321684 A1
(43) Pub. Date: Nov. 3, 2016

(54) Predicting Individual Customer Returns in e-Commerce

(71) Applicant: International Business Machines Corporation, Armonk, NY (US)

(72) Inventors: Xuan Chen, Beijing (CN); Miao He, Beijing (CN); Hao Ji, Beijing (CN); Chang R. Ren, Beijing (CN); Bing Shao, Beijing (CN); Qi M. Tian, Beijing (CN); Xiaobo Zheng, Beijing (CN)

(21) Appl. No.: 14/747,425

(22) Filed: Jun. 23, 2015

Related U.S. Application Data
(63) Continuation of application No. 14/700,512, filed on Apr. 30, 2015.

(51) Int. Cl. G06Q 30/02

(52) U.S. Cl. CPC G06Q 30/0202

(57) ABSTRACT

A mechanism is provided for predicting and reducing product return. For a historical regular product purchase associated with a current product purchase by a customer, a distribution of a number of product purchases and a distribution of a number of product returns is generated. A determination is made of a probability of return of the current product as a function of the number of product purchases, the number of product returns, a distance, and a browsing time. Responsive to the identified probability of return being greater than a predetermined threshold, the identified probability of return is used to reduce the probability of return of the product through one or more interactions with the product.

### BACKGROUND

The present application relates generally to an improved data processing apparatus and method and more specifically to mechanisms for predicting individual customer returns in e-commerce.

Product returns are a market reality faced by virtually every manufacturer, distributor, supplier, or retailer of commercial products. Unfortunately, handling product returns often requires a significant expenditure of resources. For example, it may be necessary to employ one or more individuals to verify that product returns satisfy the requirements of a company's return policy. Alternatively, a company might choose to avoid the increased overhead associated with additional employees and be somewhat less diligent about verifying compliance with the return policy. However, this alternative may increase costs due to the higher number of improper product returns. Either way, additional costs must either be borne by the company or passed along to the consumer.

In addition to the costs associated with verifying compliance with a return policy, even proper product returns incur additional administrative costs. Examples of such costs include shipping and handling of the returned product, repackaging and redistribution of the returned product (if appropriate), disposal of certain returned products, and the like. These costs must also be borne either by the company or by the consumer in the form of higher prices. Therefore, it is, of course, desirable to minimize costs associated with product returns to permit reduced prices to the customer and/or provide improved operating margins for the manufacturer and/or the retailer.

### SUMMARY

In one illustrative embodiment, a method, in a data processing system, is provided for predicting and reducing product return. The illustrative embodiment, for a historical regular product purchase associated with a current product purchase by a customer, generates a distribution of a number of product purchases g₁ (D, T), where D represents a deviation or distance of the purchased product from a customer's preference for the current product and where T represents a time the customer spent browsing a website for the current product. The illustrative embodiment, for the historical regular product purchase associated with the current product purchase by the customer, also generates a distribution of a number of product returns, g₂ (D, T). The illustrative embodiment determines a probability of return (Prob(return)) of the current product as a function of the number of product purchases (g₁), the number of product returns (g₂), the distance D, and the browsing time T, Prob(return)=ƒ(g₁, g₂, D, T). The illustrative embodiment uses the identified probability of return to reduce the probability of return of the product through one or more interactions with the product in response to the identified probability of return being greater than a predetermined threshold.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a product-return prediction mechanism in accordance with an illustrative embodiment;

FIG. 4A depicts one example of a generated distribution in accordance with an illustrative embodiment;

FIG. 4B depicts another example of a generated distribution in accordance with an illustrative embodiment;

FIG. 5A depicts one example of a probability of returns as a percentage of returns in accordance with an illustrative embodiment;

FIG. 5B depicts another example of a probability of returns as a percentage of returns in accordance with an illustrative embodiment; and

FIG. 6 depicts an exemplary flowchart of an operation performed by a product-return prediction mechanism in accordance with an illustrative embodiment.

### DETAILED DESCRIPTION

As stated previously, it is desirable to minimize costs associated with product returns. Thus, the illustrative embodiments provides for automatically predicting a probability of each post-purchase return based on historical purchasing and returning data and product characteristics associated with each customer. That is, actively predicting customer post-purchase return on an individual customer level is an issue that raises the costs associated with product returns. Current customer return solutions mainly focus on customer returning process management and lack the predictive capability. Current solutions with predictive capability only provide customer return prediction for products from a macro level, which is not accurate when it comes down to each individual purchase. Thus, the mechanisms of the illustrative embodiments provide an integrated approach to predict customers' merchandise returns in E-commerce by predicting customers' tastes towards different products and predicting a probability that a customer will return a previously bought product. The mechanisms of the illustrative embodiments provide a solution to post-purchase customer return prediction by predicting a customer's probability of returning the purchased product on an individual level based on a taste associated with the customer. Further, the mechanisms of the illustrative embodiments dynamically update each probability each time new data is available and thus, provide a dynamically evolving approach to adapt to newly available data.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

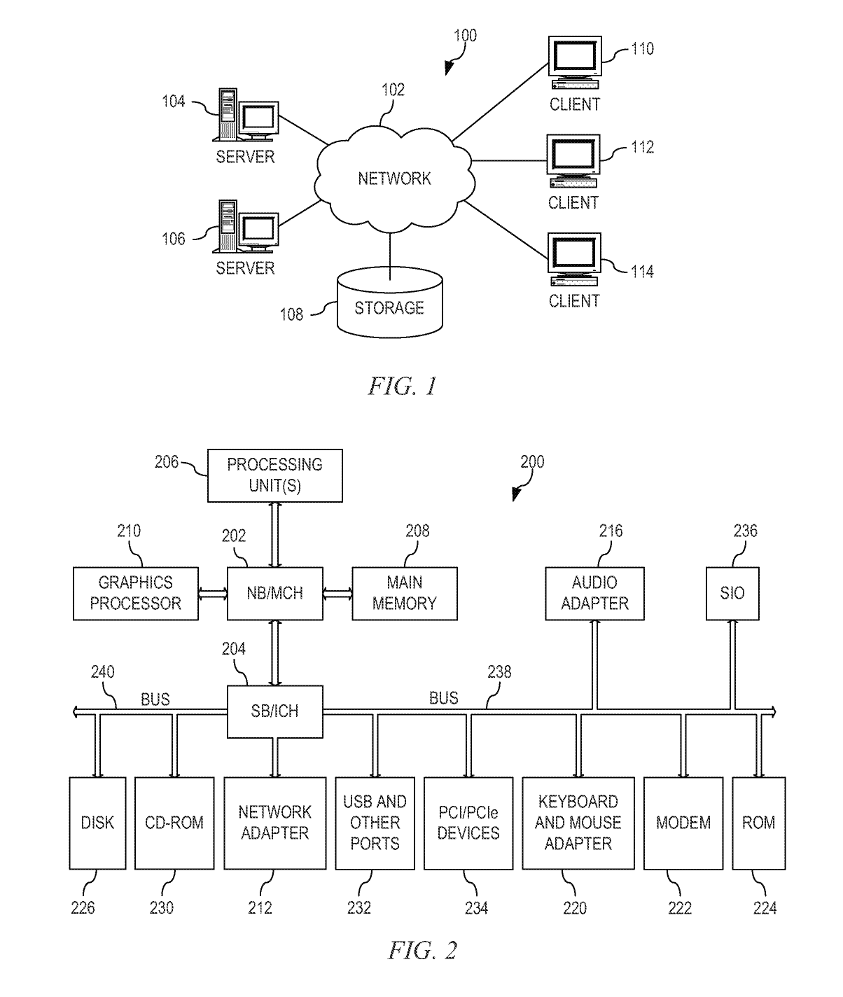

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

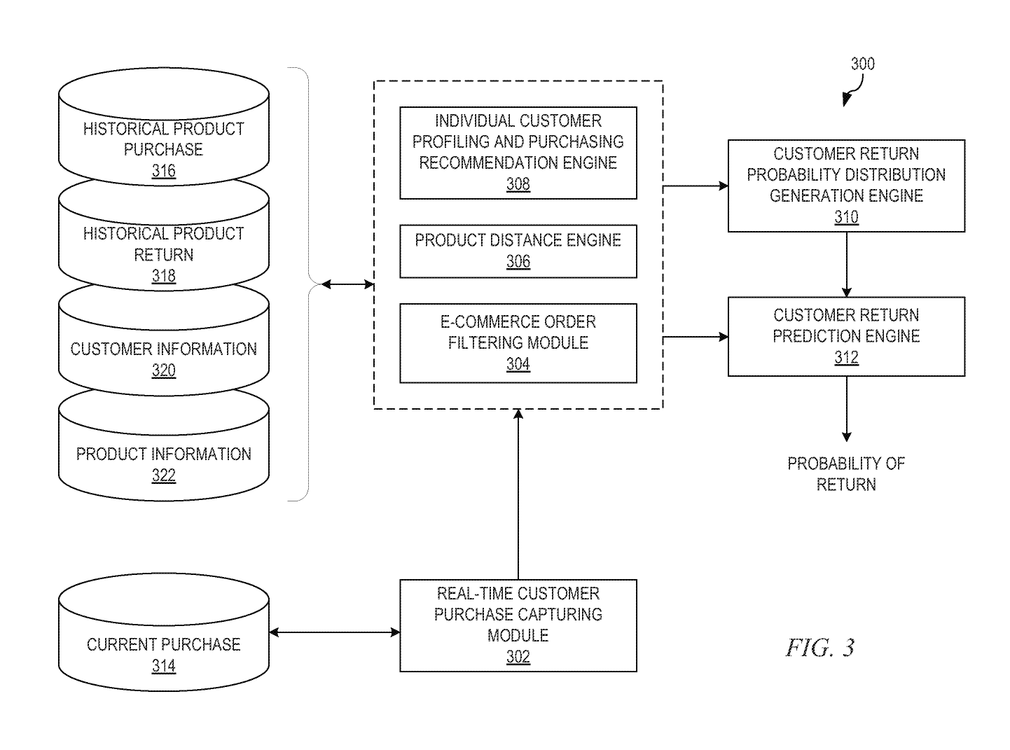

FIG. 3 depicts a functional block diagram of a product-return prediction mechanism in accordance with an illustrative embodiment. Product-return prediction mechanism 300 comprises real-time customer purchase capturing module 302, e-commerce order filtering module 304, product distance engine 306, individual customer profiling and purchasing recommendation engine 308, customer return probability distribution generation engine 310, and customer return prediction engine 312. In order to accurately predict whether a customer may return a purchased product for a current product purchase, real-time customer purchase capturing module 302 captures purchase information from a customer's interaction from a client device, such as client device 110 in FIG. 1, to a server, such as 104 in FIG. 1, via a network, such as network 102 in FIG. 1. Real-time customer purchase capturing module 302 captures the purchase information such as viewed products, purchased product(s), a shipping address for the purchased product(s), a time spent on the website hosted by the server where the product(s) were purchased, or the like. The purchase information may come from a data structure, such as current purchase data structure 314, or from direct interaction with the application where the customer's interaction via the client device occurs.

Utilizing the purchase information, e-commerce order filtering module 304 filters the product(s) purchased by the customer that are non-regular purchases. Utilizing historical product(s) purchases from historical product purchase data structure 316, historical return information from historical product return data structure 318, customer information from customer information data structure 320, and product information from product information data structure 322, e-commerce order filtering module 304 may, for example, determine whether the shipping address is not the customer's registered address, as identified from customer information in customer information data structure 320, and thus, the purchased product(s) may be a gift for another person other than the customer. Accordingly, e-commerce order filtering module 304 filters the purchased product(s) being sent to the different address from further analysis. As another example, if the customer recently bought a same product, as identified from historical product purchase data structure 316, as the purchased product(s) within a predetermined time frame, then e-commerce order filtering module 304 may determine that either the product(s) is one that the customer wants and will not be returned or one purchased for another person and will not be returned by the purchasing customer. Accordingly, e-commerce order filtering module 304 filters product(s) purchase within the predetermined time frame. As yet another example, if the purchased product(s) is not within the predetermined time from of the same product previously purchased by the customer, e-commerce order filtering module 304 may use a statistical hypothesis test to determine how significant it is that purchased product(s) with a different shipping addresses and/or repeated purchases are different from other purchases. That is, e-commerce order filtering module 304 may determine whether an average return rate of product(s) purchased with different shipping addresses is the same as other purchases and/or whether an average return rate of a repeated product(s) purchases is the same as other product(s) purchases. If either of these statistical hypotheses is null, then e-commerce order filtering module 304 filters the product(s) purchases.

For those products not filtered out by e-commerce order filtering module 304, product distance engine 306 analyzes the current purchase to determine how far each purchased product(s) deviates from the customer's preference. That is, individual customer profiling and purchasing recommendation engine 308 profiles the customer based on historical product(s) purchases from historical product purchase data structure 316, historical return information from historical product return data structure 318, customer information from customer information data structure 320, and product information from product information data structure 322 to determine which product(s) the customer is most likely to purchase and which product(s) from previously purchased product(s) the customer is most likely to return. Individual customer profiling and purchasing recommendation engine 308 may perform either exact match product analysis, similar product category analysis, or the like.

Utilizing the customer profile information, product distance engine 306 determines how far each purchased product(s) deviates from the customer's preference and records the “distance” D for each purchased product. Additionally, for each purchased product, product distance engine 306 records a time spent browsing for the product as identified by real-time customer purchase capturing module 302. Product distance engine 306 records the time T because, if the customer spent a short amount of time viewing the products, i.e. less than some predetermined time threshold, then the customer is more likely to purchase the product by mistake based on historical product purchase return information identified from historical product purchase data structure 316.

For each historical regular product purchase associated with the current product purchase, customer return probability distribution generation engine 310 uses the distance D and the browsing time T to generate a distribution of the number of product purchases against the distance and time, i.e. the number of product purchases=g₁(D, T). Customer return probability distribution generation engine 310 also uses the distance D and the browsing time T to generate a distribution of the number of product returns against the distance and browsing time, i.e. the number of product returns=g₂(D, T). Customer return probability distribution generation engine 310 then determines a probability of return based on a relationship between the number of product purchases (g₁), the number of product returns (g₂), the distance D, and the browsing time T, i.e. Prob(return)=f(g₁, g₂, D, T).

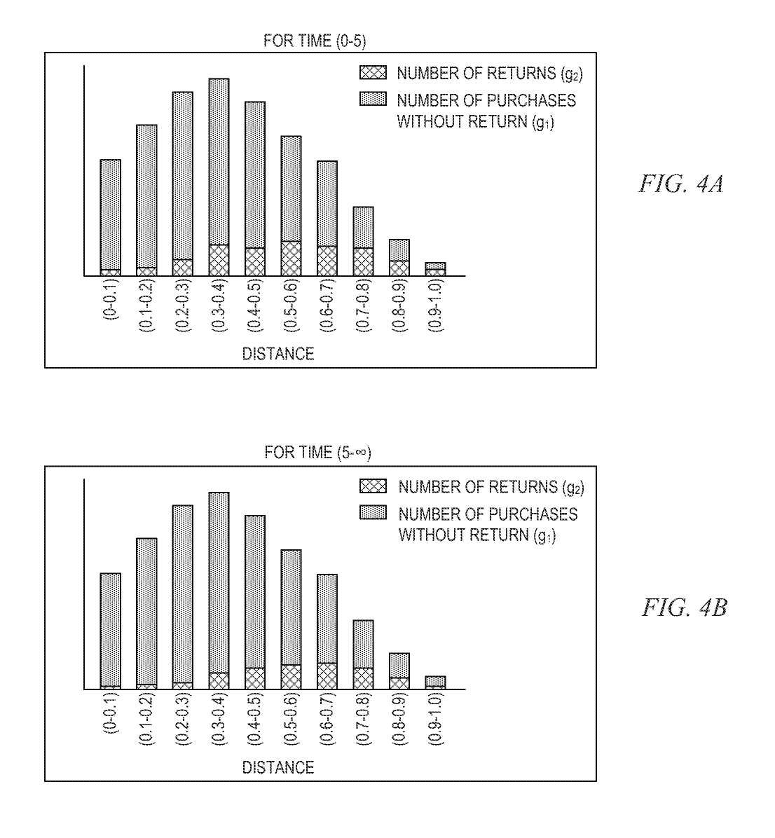

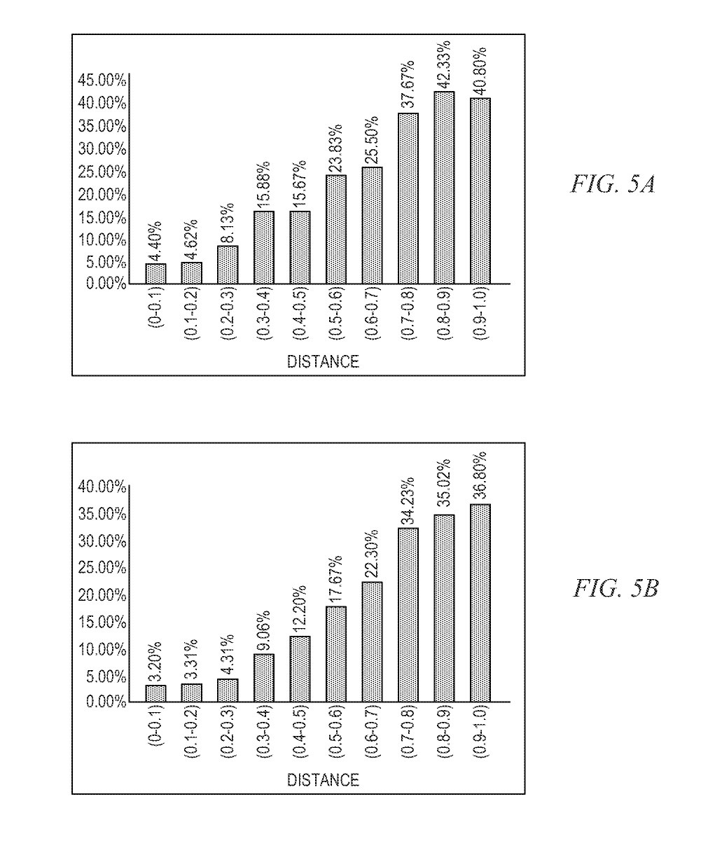

As an example, consider ten intervals of distance D and two intervals of browsing time T, such as distance D intervals of: (0-0.1), (0.1-0.2), . . . , and (0.9-1) and browsing time T(mins) of: (0-5) and (5-∞). Thus, when T=(0-5), customer return probability distribution generation engine 310 generates a distribution such as the exemplary distribution depicted in FIG. 4A in accordance with one illustrative embodiment. Further, when T=(5-∞), customer return probability distribution generation engine 310 generates a distribution such as the exemplary distribution depicted in FIG. 4B in accordance with another illustrative embodiment. Utilizing the distributions of the number of returns to the number of purchases without returns over the distances D and over the two browsing time frames T=(0-5) and T=(5-∞) as depicted in FIGS. 4A and 4B, respectively, customer return probability distribution generation engine 310 generates a probability of return for each of the distances D over the associated browsing time frames T=(0-5) and T=(5-∞). FIG. 5A depicts the probability of returns, i.e. Prob(return)=f(g₁, g₂, D, T) where T=(0-5), as a percentage of returns in accordance with one illustrative embodiment. FIG. 5B depicts the probability of returns, i.e. Prob(return)=f(g₁, g₂, D, T) where T=(5-∞), as a percentage of returns in accordance with another illustrative embodiment. Most notable between the two distributions is the decrease in the number of returns when customers take longer than 5 minutes to review and purchase a product across all of the distances. While the examples depicted in FIGS. 4A, 4B, 5A, and 5B considers ten intervals of distance D and two intervals of browsing time T, one of ordinary skill in the art will recognize that these are just examples and, in a real implementation, more intervals of both distance D and browsing time T would be used to generate more accurate estimations of return probability.

Once customer return probability distribution generation engine 310 has generated the probability of return for each of the distances and browsing time frames, then, for a distance D and a browsing time T of a current purchase, customer return prediction engine 312 maps the calculated distance D and browsing time T of the current purchase to a probability of return. For example, if a current purchase has a distance D equal to 0.72 and a browsing time equal to 4 minutes, then the Prob(return)=f(g₁, g₂, 0.72, (0-5)) indicates, using the example of FIG. 5A, a probability of return to be 37.67 percent. That is, customer return prediction engine 312 selects the probability of returns of FIG. 5A because the time of 4 minutes is between the 0 minute and 5 minutes time frame. Further, customer return prediction engine 312 selects the distance of 0.7-0.8 because of the identified distance of 0.72.

Accordingly, customer return prediction engine 312 presents the identified probability of return of 37.67 percent and using the identified probability product-return prediction mechanism 300 may cause any number of operations to be affected. For example, if the probability of return is over a predetermined threshold, product-return prediction mechanism 300 may cause an inventory management system to reduce future orders of the associated product because the probability return is high enough that a returned product could be used to fulfill a subsequent product order. As another example, if the probability of return is over a predetermined threshold, product-return prediction mechanism 300 may cause a product development system to indicate that the product needs to be improved so as to reduce product return. As yet another example, if the probability of return is over a predetermined threshold, product-return prediction mechanism 300 may cause a preemptive notice to be presented to the customer after the customer has placed a product in an electronic purchase cart on the website but before the customer has finalized the purchase. That is, if the customer has placed the product in the electronic purchase cart and the browsing time is under 5 minutes and the identified probability of return is over a predetermined threshold, then product-return prediction mechanism 300 may cause the customer to review the product one last time before the product purchase is finalized. As a further example, if the probability of return is over a predetermined threshold, product-return prediction mechanism 300 may cause the shopping website or application development system to improve the product description page to reduce purchasing mistakes. As even a further example, if the probability of return is over a predetermined threshold, product-return prediction mechanism 300 may cause a customer relationship management (CRM) system to send out reward coupons to incentivize the customer to keep the purchased product(s).

Thus, the product-return prediction mechanism 300 automatically predicts individual post-purchase customer returns in real time based on historical purchasing and returning information and product characteristics. The product-return prediction mechanism 300 dynamically updates the probability of return with each purchase and each return so as to provide a dynamically evolving approach to adapt to newly available data. Accordingly, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java. Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

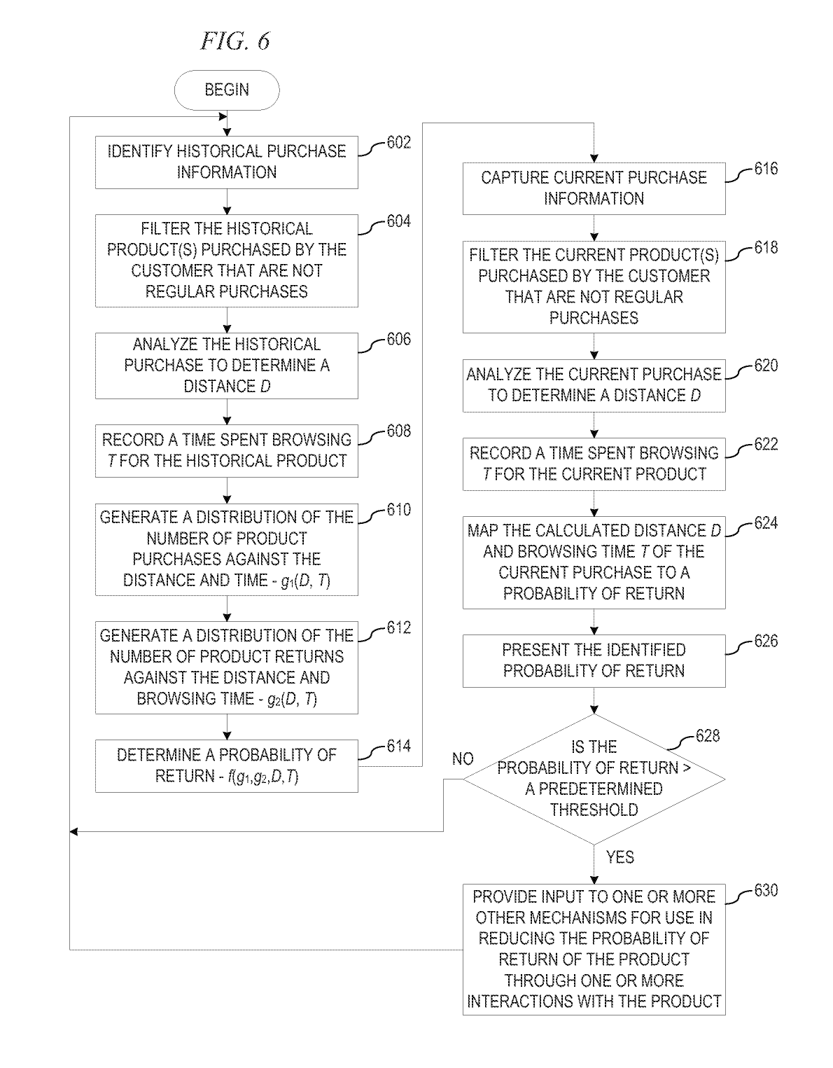

FIG. 6 depicts an exemplary flowchart of an operation performed by a product-return prediction mechanism in accordance with an illustrative embodiment. As the operation begins, the product-return prediction mechanism, executed by a processor, identifies historical purchase information (step 602) such as historically viewed products, historically purchased product(s), a shipping address for the historically purchased product(s), time spent browsing the website hosted by the server where the historically viewed product(s) were purchased, or the like. The historical purchase information may come from a data structure of previous direct interaction with the application where the customer's interaction via the client device occurs. Utilizing the historical purchase information, the product-return prediction mechanism filters the historical product(s) purchased by the customer that are non-regular purchases (step 604). For those products not filtered out, the product-return prediction mechanism analyzes the historical purchases to determine how far each historically purchased product deviates from the customer's preference, i.e. a distance D (step 606). That is, the product-return prediction mechanism profiles the customer based on historical product(s) purchases, historical return information, customer information, and product information to determine which product(s) the customer is most likely to purchase and which product(s) from previously purchased product(s) the customer is most likely to return. The product-return prediction mechanism may perform either exact match product analysis, similar product category analysis, or the like.

Additionally, for each historically purchased product, the product-return prediction mechanism records a time spent browsing T for the product (step 608). For each historical regular product purchase associated with the current product purchase, the product-return prediction mechanism uses the distance D and the browsing time T to generate a distribution of the number of product purchases against the distance and time, i.e. the number of product purchases=g₁ (D, T) (step 610). The product-return prediction mechanism also uses the distance D and the browsing time T to generate a distribution of the number of product returns against the distance and browsing time, i.e. the number of product returns=g₂ (D, T) (step 612). The product-return prediction mechanism then determines a probability of return based on a relationship between the number of product purchases (g₁), the number of product returns (g₂), the distance D, and the browsing time T, i.e. Prob(return)=f(g₁, g₂, D, T) (step 614).

Once the historical information is determined, then, for a currently purchased product, the product-return prediction mechanism, executed by a processor, captures current purchase information (step 616) such as currently viewed products, currently purchased product(s), a shipping address for the currently purchased product(s), time spent browsing the website hosted by the server where the currently purchased product(s) were purchased, or the like. The current purchase information may come from a data structure or from direct interaction with the application where the customer's interaction via the client device occurs. Utilizing the current purchase information, the product-return prediction mechanism filters the current product(s) purchased by the customer that are non-regular purchases (step 618). For those products not filtered out, the product-return prediction mechanism analyzes the current purchases to determine how far each currently purchased product deviates from the customer's preference, i.e. a distance D (step 620). That is, the product-return prediction mechanism profiles the customer based on historical product(s) purchases, historical return information, customer information, and product information to determine which product(s) the customer is most likely to purchase and which product(s) from previously purchased product(s) the customer is most likely to return. The product-return prediction mechanism may perform either exact match product analysis, similar product category analysis, or the like. Additionally, for each currently purchased product, the product-return prediction mechanism records a time spent browsing T for the product (step 622).

Once the product-return prediction mechanism has generated the probability of return for each of the distances and one or more time frames, then, for a distance D and a browsing time T of a current purchase, the product-return prediction mechanism maps the calculated distance D and browsing time T of the current purchase to a probability of return (step 624). The product-return prediction mechanism then presents the identified probability of return (step 626). The product-return prediction mechanism then determines whether the identified probability of return is greater than a predetermined probability threshold (step 628). If at step 628 the product-return prediction mechanism determines that the identified probability of return is less than or equal to the predetermined probability threshold, then the operation returns to step 602. If at step 628 the product-return prediction mechanism determines that the identified probability of return is greater than the predetermined probability threshold, then the product-return prediction mechanism provides input to one or more other mechanisms for use in reducing the probability of return of the product through one or more interactions with the product (step 630) with the operation returning to step 602 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for automatically predicting a probability of each post-purchase return based on historical purchasing and returning data and product characteristics associated with each customer. The mechanisms provide an integrated approach to predict customers' merchandise returns in E-commerce by predicting customers' tastes towards different products and predicting a probability that a customer will return a previously bought product. The mechanisms provide a solution to post-purchase customer return prediction by predicting a customer's probability of returning the purchased product on an individual level based on a taste associated with the customer. Further, the mechanisms dynamically update each probability each time new data is available and thus, provide a dynamically evolving approach to adapt to newly available data.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system, for predicting and reducing product return, the method comprising:
for a historical regular product purchase associated with a current product purchase by a customer:
generating, by a processor in the data processing system, a distribution of a number of product purchases g₁ (D, T), wherein D represents a deviation or distance of the purchased product from a customer's preference for the current product and wherein T represents a time the customer spent browsing a website for the current product; and
generating, by the processor, a distribution of a number of product returns, g₂(D, T);
determining, by the processor, a probability of return (Prob(return)) of the current product as a function of the number of product purchases (g₁), the number of product returns (g₂), the distance D, and the browsing time T, Prob(return)=f(g₁, g₂, D, T); and
responsive to the identified probability of return being greater than a predetermined threshold, using, by the processor, the identified probability of return to reduce the probability of return of the product through one or more interactions with the product.

2. The method of claim 1, further comprising:
presenting, by the processor, the identified probability of return to a user.

3. The method of claim 1, wherein the current product is identified as a product for which the identified probability of return is to be determined based on a filtering process that filters out products purchased by the customer that are non-regular product purchases.

4. The method of claim 1, wherein a non-regular product purchase is at least one of a product purchase for another person as identified by utilization of a shipping address other than an address recorded for the customer or a purchase of a product that is the same as the current product within a predetermined time frame.

5. The method of claim 1, wherein reducing the probability of return of the product comprises:
responsive to the probability of return being over the predetermined threshold, reducing, by the processor, future orders of the current product.

6. The method of claim 1, wherein reducing the probability of return of the product comprises:
responsive to the probability of return being over the predetermined threshold, instantiating, by the processor, a product improvement resulting in a better product with a lower probability of return.

7. The method of claim 1, wherein reducing the probability of return of the product comprises:
responsive to the probability of return being over the predetermined threshold, presenting, by the processor, a preemptive notice to the customer causing the customer to review the product one last time before finalization of purchase of the current product.

8. The method of claim 1, wherein reducing the probability of return of the product comprises:
responsive to the probability of return being over the predetermined threshold, instantiating, by the processor, an improvement to a product description page associated with the product in order to reduce purchasing mistakes.

9. The method of claim 1, wherein reducing the probability of return of the product comprises:
responsive to the probability of return being over the predetermined threshold, sending out, by the processor, reward coupons to incentivize the customer to keep the current product.

10-20. (canceled)
